(19) United States
(12) Patent Application Publication
(10) Pub. No.: US 2006/0046139 A1
(43) Pub. Date: Mar. 2, 2006

(54) Battery pack and its manufacturing method

(75) Inventors: Fumihiko Suzuki, Fukushima (JP); Mitsuo Sakamoto, Tokyo (JP)

Correspondence Address: SONNENSCHEN NATH & ROSENTHAL;Sears Tower, Wacker Drive Station, P.O. Box 061080, Chicago, IL, 60606-1080, US

(73) Assignee: Sony Corporation

(21) Appl. No.: 11/205,945

(22) Filed: Aug. 17, 2005

(30) Foreign Application Priority Data
Aug. 24, 2004 (JP) P2004-243892

(51) Int. Cl. H01M 2/04; H01M 2/08; H01M 10/04

(52) U.S. Cl. 429/175; 429/185; 429/176; 29/623.2; 29/623.4

(57) ABSTRACT

A battery pack is disclosed that has at least a battery device enclosed in an external package and a cover adapted to be fitted into an opening formed at one end of the battery device enclosed in the external package. The cover includes a lower molding body, a circuit substrate arranged on the side of the lower molding body opposite to the side of the battery device, and an upper molding body provided on the circuit substrate. The circuit substrate and a lead led out of said opening are joined, and the battery device enclosed in the external package and the cover are adhered with a resin.

### CROSS REFERENCES TO RELATED APPLICATIONS

The present invention contains subject matter related to Japanese Patent Application No. 2004-243892 filed in the Japanese Patent Office on Aug. 24, 2004, the entire contents of which being incorporated herein by reference.

### BACKGROUND OF THE INVENTION

1. Field of the Invention

The invention relates to a battery pack having a circuit substrate in an external package and to its manufacturing method.

2. Description of the Related Arts

In recent years, as a power source of a portable electronic apparatus, a battery pack in which a protecting circuit substrate on that a protecting circuit and the like have been mounted and a battery device are enclosed in an external package has been used. A box-shaped casing formed by upper and lower casings and the like is widely used as an external package which is used for the battery pack as mentioned above (for example, refer to JP-A-2002-260608).

However, the above construction using such a casing has a problem of an increase in thickness. According to the current molding technique, an upper limit value of the thickness of casing is equal to about 0.2 to 0.3 mm. Such a technique that the protecting circuit substrate on which the protecting circuit has been mounted and the battery device are integratedly molded by resin molding has been proposed (for example, refer to JP-A-2003-162987).

FIG. 15 is a cross sectional view for explaining a method of integratedly molding the protecting circuit substrate and the battery device by the resin molding. First, as shown in FIG. 15, a lead 103 connected to a positive electrode and a negative electrode of the battery device is bent and a protecting circuit substrate 102 is arranged in an opening of an edge surface of a front side of an external package 101. A protecting circuit having a protecting device such as PTC, fuse, thermistor, or the like and the like are mounted on the protecting circuit substrate 102. After that, they are put into a dedicated die and integratedly molded by the resin molding.

### SUMMARY OF THE INVENTION

However, in the related battery pack with such a construction, since resin melting heat upon molding is directly transferred to electronic parts mounted on the protecting circuit substrate, there is such a problem that the electronic parts are damaged.

It is desirable to provide a battery pack in which a protecting circuit substrate and a battery device can be integrated without damaging electronic parts provided for a protecting circuit and to provide its manufacturing method.

To solve the above problem, according to an embodiment of the present invention, there is provided a battery pack having at least a battery device enclosed in an external package and a cover adapted to be fitted into an opening formed at one end of the battery device enclosed in the external package, wherein
the cover comprises:
a lower molding body;
a circuit substrate arranged on the side of the lower molding body opposite to the side of the battery device; and
an upper molding body provided on the circuit substrate,
the circuit substrate and a lead led out of the opening are joined, and
the battery device enclosed in the external package and the cover are adhered with a resin.

According to the embodiment of the present invention, since the lower molding body exists between the circuit substrate and the molten resin, by filling the molten resin between the cover and the battery device and solidifying it, when the cover and the battery device are adhered, it is possible to prevent heat of the molten resin from being propagated to the circuit substrate.

According to another embodiment of the present invention, there is provided a manufacturing method of a battery pack, comprising the steps of:
arranging a circuit substrate to a lower molding body;
providing an upper molding body onto the circuit substrate;
joining an upper surface of the circuit substrate arranged on the lower molding body and a lead led out of an opening provided at one end of a battery device enclosed in an external package;
inserting the lower molding body into the opening so that the surface where the circuit substrate is arranged faces the outside; and
injecting a resin between the lower molding body and the battery device and hardening it.

According to the embodiment of the present invention, since the lower molding body exists between the circuit substrate and the molten resin, it is possible to prevent the heat of the molten resin filled between the lower molding body and the battery device from being directly propagated to the circuit substrate.

According to another embodiment of the present invention, there is provided a manufacturing method of a battery pack, comprising the steps of:
arranging a circuit substrate to a lower molding body;
joining an upper surface of the circuit substrate arranged on the lower molding body and a lead led out of an opening provided at one end of a battery device enclosed in an external package;
inserting the lower molding body into the opening so that the surface where the circuit substrate is arranged faces the outside; and
filling a resin onto the circuit substrate, forming an upper molding body, injecting the resin between the lower molding body and the battery device, and hardening it.

According to the embodiment of the present invention, since the lower molding body exists between the circuit substrate and the molten resin, it is possible to prevent the heat of the molten resin filled between the lower molding body and the battery device from being directly propagated to the circuit substrate.

As described above, according to an embodiment of the invention, since the lower molding body is inserted into the opening so that the surface of the lower molding body where the circuit substrate has been arranged faces the outside and the resin is injected between the lower molding body and the battery device and hardened, it is possible to prevent the heat of the molten resin from being directly propagated to the circuit substrate. Therefore, the circuit substrate and the battery device can be integrated without damaging the electronic parts provided for the circuit substrate.

The above and other features of the present invention will become apparent from the following detailed description and the appended claims with reference to the accompanying drawings.

### BRIEF DESCRIPTION OF THE DRAWINGS

FIG. 1 is an exploded perspective view showing an example of a construction of a battery pack according to an embodiment of the invention;

FIG. 2 is a perspective view showing an example of an external view of a battery device according to the embodiment of the invention;

FIG. 3 is a perspective view showing an example of an external view of the battery device covered with an external package;

FIGS. 4A, 4B, and 4C are development diagrams showing an example of a shape of the external package which covers the battery device;

FIG. 5 is across sectional view showing an example of a construction of laminating materials constructing the external package;

FIG. 6 is a cross sectional view showing a joint portion of the external package;

FIG. 7 is an exploded perspective view showing an example of a construction of a front cover;

FIG. 8 is an exploded perspective view showing an example of the construction of the front cover;

FIG. 9 is a cross sectional view showing an example of a shape of a resin injection hole formed in the front cover;

FIG. 10 is a perspective view for explaining an example of a manufacturing method of the battery pack according to the embodiment of the invention;

FIG. 11 is a perspective view for explaining an example of the manufacturing method of the battery pack according to the embodiment of the invention;

FIG. 12 is a perspective view for explaining an example of the manufacturing method of the battery pack according to the embodiment of the invention;

FIG. 13 is a perspective view for explaining an example of the manufacturing method of the battery pack according to the embodiment of the invention;

FIG. 14 is a perspective view for explaining an example of the manufacturing method of the battery pack according to the embodiment of the invention; and

FIG. 15 is a cross sectional view for explaining a construction of a related battery pack.

### DETAILED DESCRIPTION OF THE PREFERRED EMBODIMENT

An embodiment of the invention will be described hereinbelow with reference to the drawings. The same or corresponding portions in all diagrams of the following embodiment are designated by the same reference numerals.

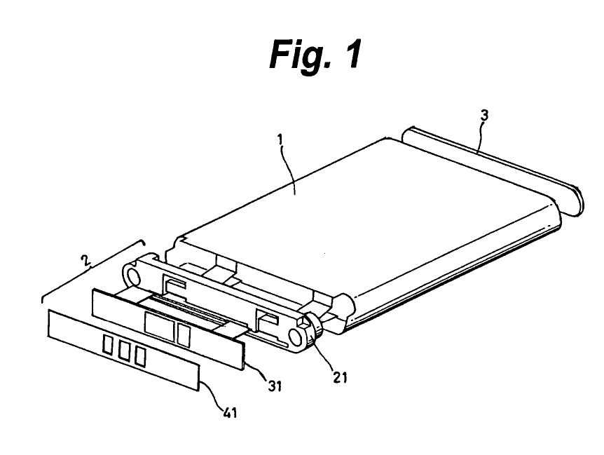

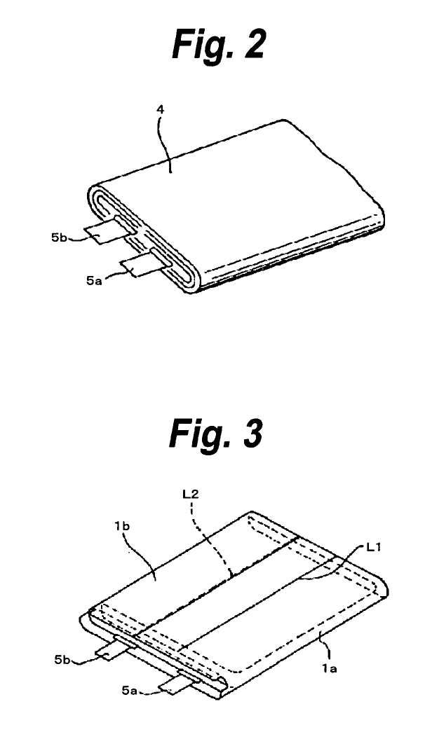

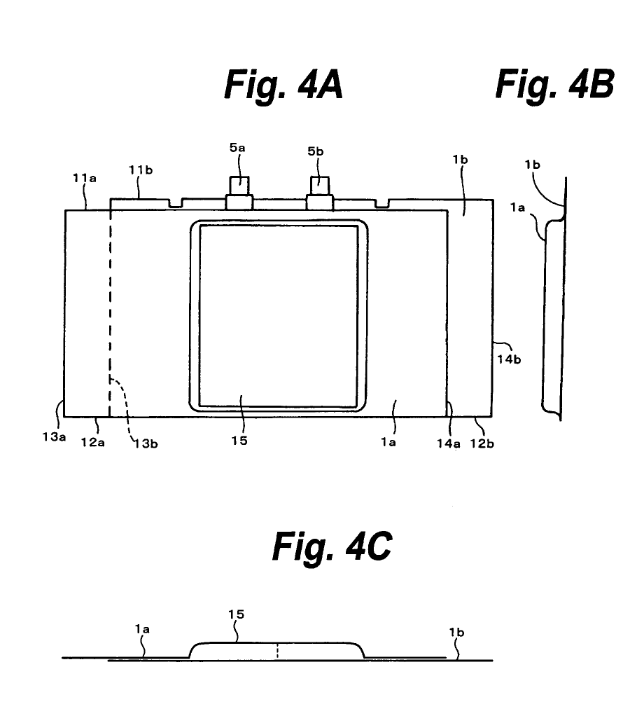

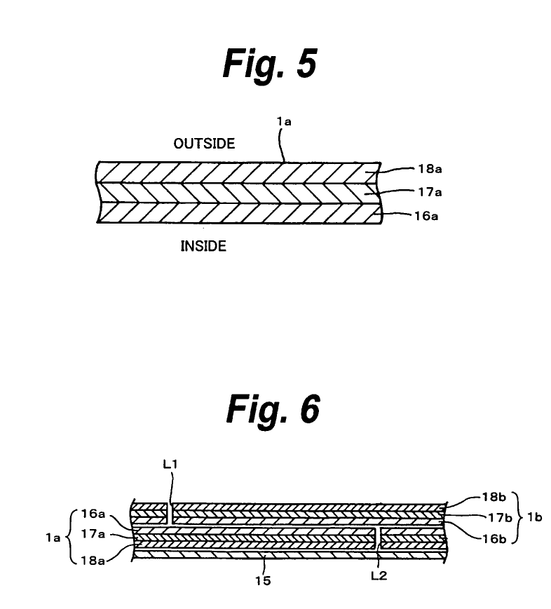

FIG. 1 is an exploded perspective view showing an example of a construction of a battery pack according to an embodiment of the invention. FIG. 2 is a perspective view showing an example of an external view of a battery device according to the embodiment of the invention. FIG. 3 is a perspective view showing an example of an external view of the battery device covered with an external package. FIGS. 4A, 4B, and 4C are development diagrams showing an example of a shape of the external package which covers the battery device. FIG. 5 is a cross sectional view showing an example of a construction of laminating materials constructing the external package. FIG. 6 is a cross sectional view showing a joint portion of the external package.

As shown in FIG. 1, the battery pack has: a battery device 4 covered with an external package 1; a front cover 2; and a rear cover 3. Both ends of the battery device 4 covered with the external package 1 are opened. The front cover 2 is provided for one opening and the rear cover 3 is provided for the other opening. Hereinbelow, the side where the front cover 2 is provided is called a front side and the side where the rear cover 3 is provided is called a rear side.

<Battery Device>

As shown in FIG. 2, in the battery device 4, a belt-shaped positive electrode and a belt-shaped negative electrode are laminated through a polymer electrolyte and/or a separator and wound in the longitudinal direction and leads 5a and 5b are led out of the positive electrode and the negative electrode, respectively. The battery device 4 is, for example, a lithium polymer secondary battery.

In the positive electrode, a positive electrode active substance layer is formed on a belt-shaped positive electrode collector and a polymer electrolyte layer is further formed on the positive electrode active substance layer. In the negative electrode, a negative electrode active substance layer is formed on a belt-shaped negative electrode collector and a polymer electrolyte layer is further formed on the negative electrode active substance layer. The leads 5a and 5b are joined to the positive electrode collector and the negative electrode collector, respectively. Materials which have already been proposed can be used for the positive electrode active substance, the negative electrode active substance, and the polymer electrolyte.

The positive electrode can be constructed by using a metal oxide, a metal sulfide, or a specific high polymer as a positive electrode active substance in accordance with a kind of target battery. In the case of constructing, for example, a lithium ion battery, a lithium compound oxide or the like mainly containing LixMO₂ (in which, M denotes one or more kinds of transition metals and x is ordinarily equal to a value within a range from 0.05 or more to 1.10 or less although it differs depending on a charging/discharging state of the battery) can be used as a positive electrode active substance. It is preferable to use Co, Ni, Mn, or the like as a transition metal M constructing the lithium compound oxide.

LiCoO₂, LiNiO₂, LiNi_{y}Co_{1-y}O₂ (in which, 0<y<1) LiMn₂O₄, or the like can be mentioned as a specific example of the lithium ion compound oxide. Those lithium ion compound oxides can generate a high voltage and have excellent energy density. A metal sulfide or oxide containing no lithium such as TiS₂, MOS₂, NbSe₂, V₂O₅, or the like can be also used as a positive electrode active substance. A plurality of kinds of those positive electrode active substances can be also used for the positive electrode. When the positive electrode is formed by using the positive electrode active substances as mentioned above, a conductive material, a binder, or the like can be also added.

A material which can dope or dedope lithium can be used as a negative electrode material. For example, a carbon material such as graphitization resisting carbon material or graphite material can be used. More specifically speaking, it is possible to use a carbon material such as pyrolytic carbon class, coke class (pitch coke, needle coke, petroleum coke), graphite class, vitrified carbon class, organic polymer compound baked body (obtained by baking phenol resin, furan resin, or the like at a proper temperature and carbonizing), carbon fiber, activated carbon, or the like. Further, a high polymer such as polyacetylene, polypyrrole, or the like or an oxide such as SnO₂ or the like can be used as a material which can dope or dedope lithium. When the negative electrode is made of such a material, a binder or the like can be also added.

The polymer electrolyte is made by injecting a gel electrolyte obtained by mixing a high polymer material, an electrolyte solution, and electrolyte salt into a polymer. The high polymer material has such a nature that it is miscible into the electrolyte solution and silicon gel, acrylic gel, acrylonitrile gel, polyphosphorzen denaturation polymer, polyethylene oxide, polypropylene oxide, and their compound polymer, crosslinking polymer, denaturation polymer, or the like are used as a high polymer material, or as a fluorinated polymer, for example, a high polymer material such as poly (vinylidene fluoride), poly (vinylidene fluoride-co-tetrafluoro safluoropropylene), poly (vinylidene fluoride-co-trifluoroethylene), or the like, and their mixture are used.

The electrolyte solution component can distribute the above-mentioned high polymer materials. For example, ethylene carbonate (EC), propylene carbonate (PC), butylene carbonate (BC), or the like is used as a non-protic solvent. A material which is miscible with a solvent is used as electrolyte salt. A cation and an anion are combined. An alkali metal or an alkali earth metal is used as a cation. Cl⁻, Br⁻, I⁻, SCN⁻, ClO₄⁻, BF₄⁻, PF₆⁻, CF₃SO₃⁻, or the like is used as an anion. Specifically speaking, hexafluoride lithium phosphate or tetrafluoride lithium borate is used as electrolyte salt at such a density that it is soluble into the electrolyte solution.

<External Package>

The external package 1 is, for example, a hard laminating material and is formed by two kinds of laminating materials 1a and 1b as shown in FIGS. 4A, 4B, and 4C. A concave portion to enclose the battery device 4 is provided for the laminating material 1a. The concave portion is formed by, for example, drawing. A thermally melt-bonding sheet 15 is arranged on the outer surface at a position corresponding to the bottom surface of the concave portion.

As a laminating material 1a, it is preferable to use a material which is suitable to form the concave portion by the drawing and is softer than the laminating material 1b. As shown in FIG. 5, the laminating material 1a has a laminated structure obtained by sequentially laminating a polypropylene (PP) layer 16a as an adhesive layer, a soft aluminum metal layer 17a as a metal layer, and a nylon layer or PET (polyethylene terephthalate) layer 18a (hereinafter, referred to as a nylon/PET layer 18a) as a surface protective layer. The polypropylene (PP) layer 16a is located on the inside (the side where it is come into contact with the laminating material 1b).

The polypropylene (PP) layer 16a has a function of preventing alteration of the polymer electrolyte. A cast polypropylene (CPP) or the like is used as a polypropylene (PP) layer 16a. A thickness of polypropylene (PP) layer 16a is equal to, for example, about 30 μm.

The soft aluminum metal layer 17a has a function of preventing the moisture from entering the inside. As a material of the soft aluminum metal layer 17a, for example, aluminum (3003-O JIS H 4160), (3004-O JIS H 4160), or the like obtained after an annealing process can be used. A thickness of soft aluminum metal layer 17a is set to a value within approximately a range, for example, from 30 to 130 μm. The nylon/PET layer 18a has a function of protecting the surface. A thickness of nylon/PET layer 18a is set to a value within approximately a range, for example, from 10 to 30 μm.

The other laminating material 1b is a hard laminating material which maintains the shape after it was bent and can endure deformation applied from the outside. The laminating material 1b has a laminated structure obtained by sequentially laminating a polypropylene layer as an adhesive layer, a hard aluminum metal layer, and a nylon layer or PET layer as a surface protective layer.

The polypropylene layer and the nylon layer or PET layer of the laminating material 1b are similar to those of the laminating material 1a. As a hard aluminum metal layer, aluminum (3003-O JIS H 4160), (3004-O JIS H 4160), or the like obtained without performing the annealing process can be used and its thickness is set to a value within approximately a range, for example, from 30 to 130 μm. The thickness of each layer of the laminating materials 1a and 1b is selected to a proper value in consideration of a total thickness.

The laminating material 1b is arranged so as to overlap the laminating material 1a and cover the opening surface of the concave portion. In this case, as shown in FIG. 4A, it is assumed that the positional relation between the laminating materials 1a and 1b is deviated. The laminating material 1a has a front side long side 11a and a rear side long side 12a each having an equal length and has a left side short side 13a and a right side short side 14a each having an equal length. Similarly, the laminating material 1b has a front side long side 11b and a rear side long side 12b each having an equal length and has a left side short side 13b and a right side short side 14b each having an equal length. The expression of “right” and “left” shows the positional relation when they are seen as the user faces the drawing.

The front side long sides 11a and 11b and the rear side long sides 12a and 12b are set to almost the same length. The lengths of those long sides are selected so that the short sides (the short sides 13a and 14a; the short sides 13b and 14b) which face in the state where an enclosing portion of the battery device 4 is enclosed are come into contact with each other or the edge surfaces of the short sides face with a small gap.

It is assumed that the short sides 13a and 14a of the laminating material 1a are slightly shorter than the short sides 13b and 14b of the laminating material 1b. Therefore, the laminating materials 1a and 1b can be laminated so that only the laminating material 1b exists on the front side. In such a case, it is possible to obtain such an advantage that a peripheral surface of the front cover 2 provided for the opening of the front side can be thermally melt-bonded by the polypropylene layer of the laminating material 1b. Also on the rear side, it is possible to construct in such a manner that a peripheral surface of the rear cover 3 provided for the opening of the rear side can be thermally melt-bonded by the polypropylene layer of the laminating material 1b so as to expose an adhesive layer of the laminating material 1b.

As shown in FIG. 6, in the state where the battery device 4 is enclosed, the short sides 13b and 14b of the laminating material 1b are come into contact with each other or their edge surfaces face through a small gap and a joint L1 occurs. On the inside of the laminating material 1b, the short sides 13a and 14a of the laminating material 1a are come into contact with each other or their edge surfaces face through a small gap and a joint L2 occurs. In FIG. 6, reference numeral 16b denotes a polypropylene layer of the laminating material 1b; 17b a hard aluminum metal layer; and 18b a nylon layer or PET layer.

As shown in FIG. 6, the nylon/PET layer 18a of the laminating material 1a is located in contact with an upper side of the thermally melt-bonding sheet 15. Therefore, since such a structure in which the nylon/PET layer 18a sandwiches the thermally melt-bonding sheet 15 is obtained, the two nylon layer portions can be adhered or the two PET layer portions can be adhered by applying heat to them from the outside. Since the polypropylene layers 16a and 16b of the laminating materials 1a and 1b face and are come into contact with each other, the polypropylene layers 16a and 16b can be adhered by applying heat to them from the outside.

<Front Cover>

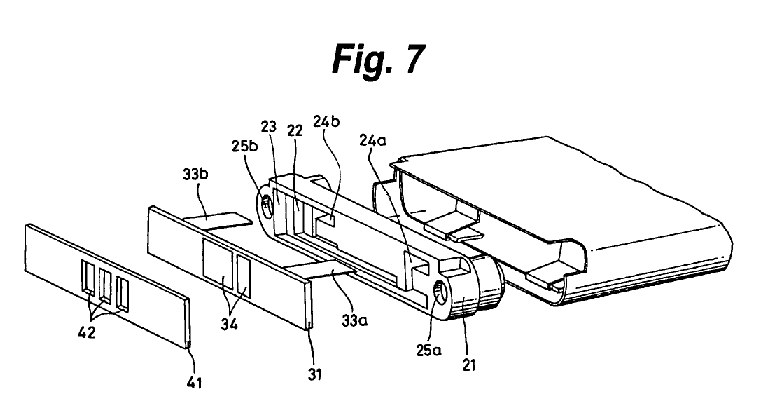

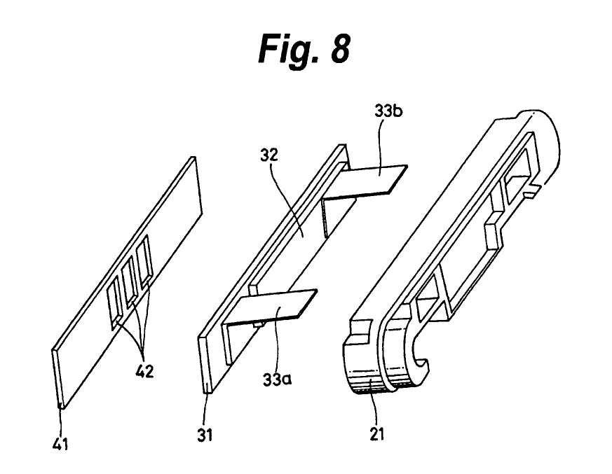

FIGS. 7 and 8 are exploded perspective views showing an example of a construction of the front cover. As shown in FIGS. 7 and 8, the front cover 2 has a lower molding body 21, a protecting circuit substrate 31, and an upper molding body 41. A cross section of the lower molding body 21 has almost the same shape as that of the opening of the front side, for example, an elongated elliptic shape. The lower molding body 21 has: a first groove 22 into which a protecting circuit 32 mounted on the protecting circuit substrate 31 is fitted; and a second groove 23 into which the protecting circuit substrate 31 is fitted. The first groove 22 and the second groove 23 are formed on the surface of the lower molding body 21 on the side opposite to the battery device 4.

The lower molding body 21 has two lead-out holes 24a and 24b at positions which are slightly inside than both end portions in the longitudinal direction. The lead-out holes 24a and 24b are through-holes for leading out auxiliary tabs 33a and 33b provided for the protecting circuit substrate 31 and are pierced from both sides where the protecting circuit substrate 31 is arranged toward the surface on the side which faces the battery device 4. For example, a resin such as polypropylene (PP) or the like can be used as a material constructing the lower molding body 21.

The lower molding body 21 has resin injection holes 25a and 25b in the both end portions in the longitudinal direction. The resin injection holes 25a and 25b are through-holes for injecting a molten resin between the edge surface of the front side of the battery device 4 and the front cover 2 fitted into the opening of the front side and pierced from both sides where the protecting circuit substrate 31 is arranged toward the surface on the side which faces the battery device 4. The case where the two resin injection holes 25a and 25b are provided for the lower molding body 21 is shown as an example here. The number of resin injection holes is not particularly limited and can be set to 1 or 2 or more.

Grooves are formed in injection port portions of the resin injection holes 25a and 25b. When the molten resin is solidified in those grooves, projections are formed and the position of the front cover 2 is fixed by the projections, thereby preventing the front cover 2 from being pulled out.

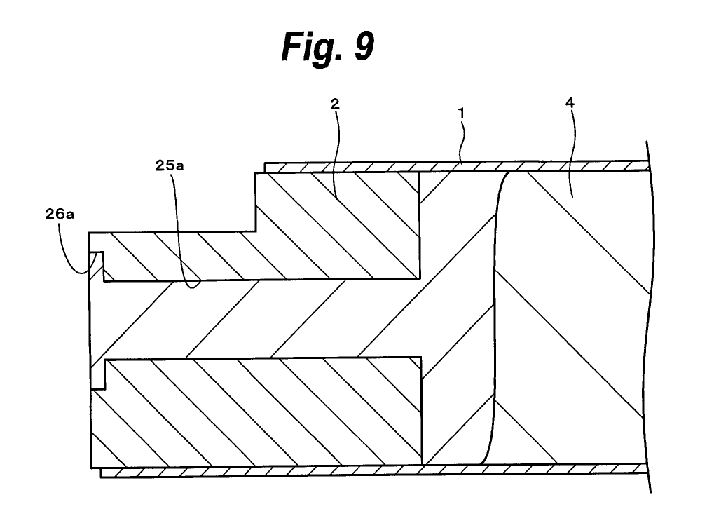

FIG. 9 is a cross sectional view showing an example of a shape of the resin injection hole 25a formed in the front cover 2. As shown in FIG. 9, the resin injection hole 25a has, for example, a cylindrical shape and a ring-shaped groove 26a is formed on the injection port side. That is, the resin injection hole 25a has a T-character-like cross sectional shape. By using such a shape, when the molten resin is filled into the groove 26a and solidified, a projection is formed in the injection port portion. The position of the front cover 2 is fixed by the projection, thereby preventing the front cover 2 from being pulled out.

The protecting circuit 32 including a temperature protecting device such as fuse, PTC, thermistor, or the like, an ID resistor to discriminate the battery pack, and the like are mounted on one principal plane of the protecting circuit substrate 31. The PTC is serially connected to the battery device. When a temperature of the battery is higher than a set temperature, an electric resistance rises suddenly, thereby substantially shutting off a current flowing in the battery. The fuse and the thermistor are also serially connected to the battery device. When the temperature of the battery is higher than the set temperature, the current flowing in the battery is shut off.

A plurality of, for example, two contact portions 34 are provided on the other principal plane of the protecting circuit substrate 31. The protecting circuit 32 is fitted into the groove 22 and the protecting circuit substrate 31 is fitted into the groove 23 so that one principal plane side on which the protecting circuit 32 and the like are provided becomes the lower molding body 21 side.

The auxiliary tabs 33a and 33b corresponding to the positive and negative electrodes are joined to the protecting circuit substrate 31 or the protecting circuit 32. The auxiliary tabs 33a and 33b are joined to the leads 5a and 5b provided at the edge surfaces of the front side of the battery device 4.

The upper molding body 41 is provided in the first groove 22 so as to cover the protecting circuit substrate 31. The upper molding body 41 has three openings 42 at the positions corresponding to the contact portions 34. The contact portions 34 face the outside through the openings 42. For example, a resin such as polypropylene (PP) or the like can be used as a material constructing the upper molding body 41.

<Rear Cover>

The rear cover 3 is used to cover the opening of the rear side and has almost the same shape as that of the opening of the rear side. For example, a resin such as polypropylene (PP) or the like can be used as a material constructing the rear cover 3.

An example of a manufacturing method of the battery pack according to an embodiment of the invention will now be described with reference to FIGS. 4A to 4C and 9 to 14.

<Manufacturing Step of Battery Device>

First, for example, the positive and negative electrodes in which the gel electrolyte layers are formed on both surfaces and separators are sequentially laminated in order of the negative electrode, the separator, the positive electrode, and the separator. An obtained laminate body is wound around a core in a flat shape in the longitudinal direction a number of times, thereby forming the winding type battery device 4.

<External Package Coating Step>

Subsequently, a concave portion into which the battery device 4 is inserted is previously formed in the laminating material 1a by, for example, deep drawing molding. In this instance, as shown in FIG. 4A, the battery device inserting concave portion of the laminating material 1a is formed, for example, in the position which is slightly deviated to the right from the center position. The battery device 4 is enclosed in the concave portion formed in the laminating material 1a.

Subsequently, as shown in FIG. 4A, the laminating material 1b is laminated in the position which is slightly deviated to the right from the laminating material 1a. Thus, in the state where the laminating materials 1a and 1b have been laminated, as shown in FIG. 4A, the left region where only the laminating material 1a is located and the right region where only the laminating material 1b is located occur. The reason why the positions are deviated as mentioned above is to enable the polypropylene layer of one of the laminating materials to be adhered to the other laminating material so as to have a certain width at a position near the joint position of the laminating materials 1a and 1b.

Subsequently, in the state of the layout relation as shown in FIG. 4A, four sides around the opening of the concave portion are sealed while reducing the pressure. In this case, the whole portion where the polypropylene layers overlap can be also thermally melt-bonded.

Subsequently, as shown in FIG. 4A, the thermally melt-bonding sheet 15 having a predetermined shape is inserted into the outside of the bottom surface of the concave portion. The thermally melt-bonding sheet 15 is an auxiliary member for adhering the nylon/PET layers 18a of the laminating material 1a, that is, the nylon layers or the PET layers by heating them at a high temperature. Preferably, a sheet whose thickness is equal to about 10 to 60 μm in consideration of the total thickness and whose melting point is equal to about 100° C. is used. It is desirable to set the melting point of the thermally melt-bonding sheet 15 to such a value that does not exert a heat influence on the battery device 4.

In the state where the laminating materials 1a and 1b are opened as shown in FIG. 4A, subsequently, their short sides (13a, 14a) and (13b, 14b) are inwardly bent so as to enclose the concave portion where the battery device 4 has been enclosed, they are thermally melt-bonded from the outside, and the closed state is fixed.

The battery pack in which the hard laminating material 1b also functions as an external package can be manufactured without using a box-shaped casing made of a resin and without arranging frames made of a resin to both sides as mentioned above.

<Fitting Step of the Front Cover>

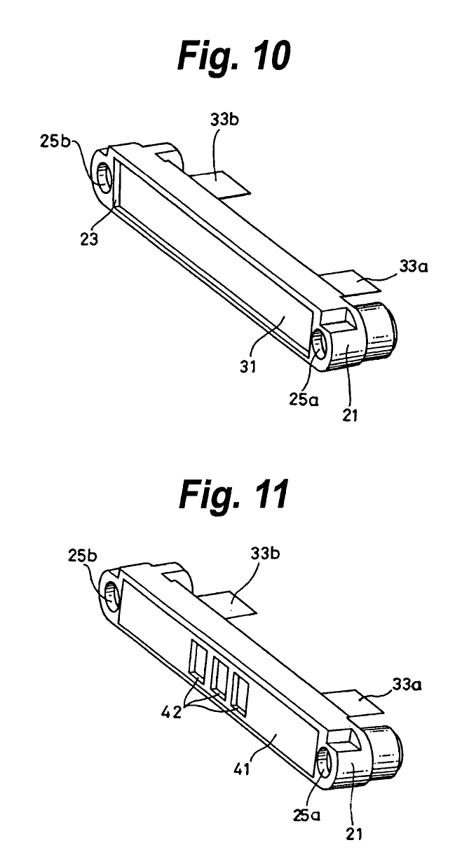

Subsequently, the lower molding body 21 is molded by, for example, an injection molding or a hot melting method. As shown in FIG. 10, the protecting circuit 32 and the protecting circuit substrate 31 are fitted into the first groove 22 and the second groove 23 so that one end of the auxiliary tab 33a is led out of the side where it faces the battery device 4 through the lead-out hole 24a and one end of the auxiliary tab 33b is also likewise led out through the lead-out hole 24b.

Subsequently, as shown in FIG. 11, the upper molding body 41 is formed onto the protecting circuit substrate 31 so as to bury the second groove 23. For example, the injection molding method or the hot melting method can be used as a forming method of the upper molding body 41. The front cover 2 is formed in this manner.

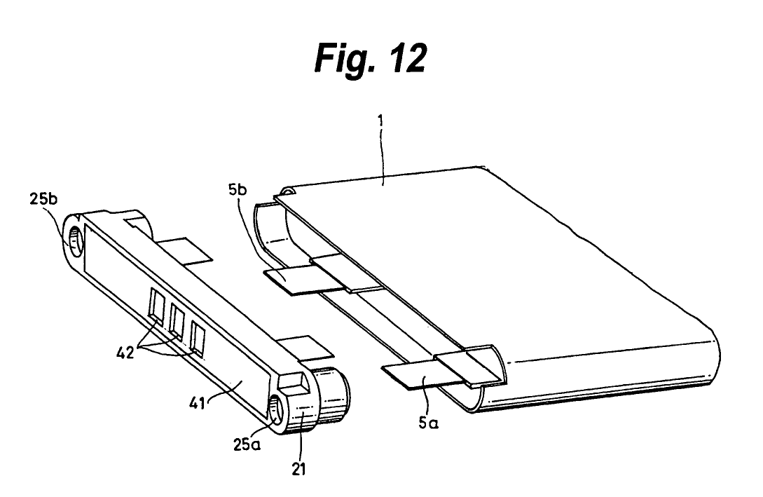

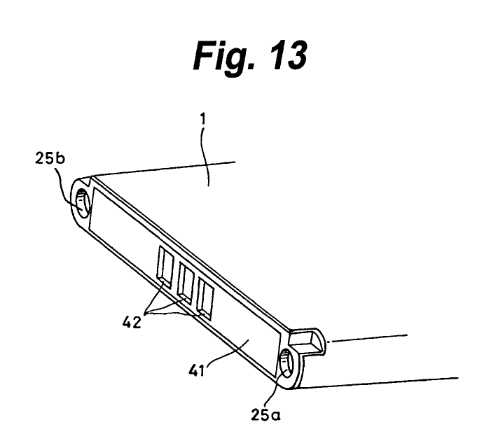

Subsequently, as shown in FIG. 12, one end of the auxiliary tab 33a is joined to the lead 5a led out of the opening of the front side by, for example, resistance welding or ultrasonic welding and one end of the auxiliary tab 33b is also likewise joined to the lead 5b. As shown in FIG. 13, the front cover 2 is fitted into the opening of the front side so that the surface on the side opposite to the protecting circuit substrate 31 faces the battery device 4 side.

Subsequently, a molten resin is filled between the lower molding body 21 and the battery device 4 through the resin injection holes 25a and 25b, a resin is also filled into the resin injection holes 25a and 25b up to the groove portions thereof, and those resins are solidified. Thus, the front cover 2 is adhered to the edge surface of the battery device 4.

As a resin to be filled, it is sufficient to use a resin having a low viscosity state upon injection molding and it is not particularly limited to such a resin. For example, a resin of a polyamide system, a hot melting resin, a polyorefin system hot melting resin, nylon, PP, PC, ABS, or the like can be used.

<Fitting Step of the Rear Cover>

Subsequently, the rear cover 3 is preliminarily formed by, for example, the injection molding or the like and fitted into the opening of the rear side of the battery device 4 covered with the external package 1. It is preferable that the surfaces between the rear cover 3 and the edge surface on the rear side of the battery device 4 are coated with an adhesive agent. A forming method of the rear cover 3 is not limited to the above method but the rear cover 3 can be also formed on the opening of the rear side by filling the molten resin into the opening of the rear side and hardening it.

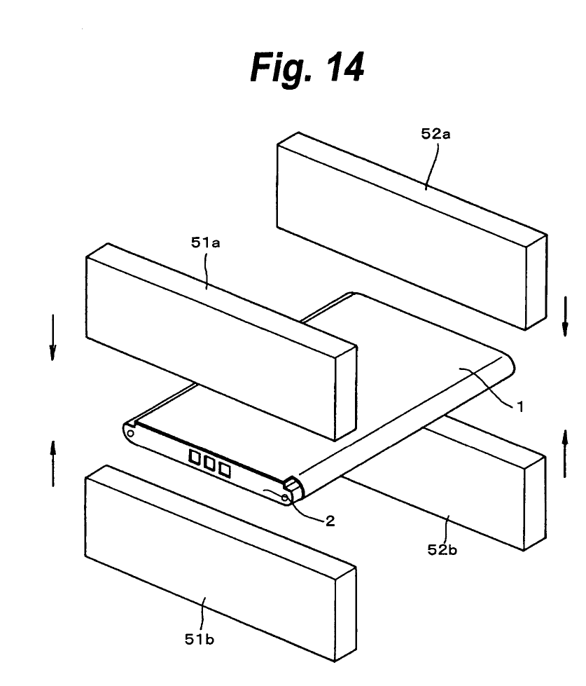

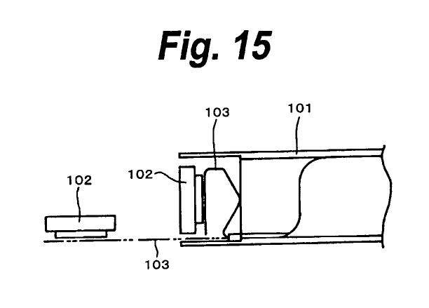

After that, the whole length is suppressed by a tool and the thermal melt-bonding is executed as shown in FIG. 14. That is, heater blocks 51a and 51b made of metal such as copper or the like are pressed to a portion near an edge of the front side of the cell 1 from the upper and lower directions. The peripheral surface of the front cover 2 and the polypropylene layer as an inner surface of the laminating material are thermally melt-bonded. Similarly, it is also possible to construct in such a manner that heater blocks 52a and 52b are pressed to a portion near an edge of the bottom side of the cell 1 from the upper and lower directions and the peripheral surface of the rear cover 3 and the polypropylene layer as an inner surface of the laminating material are thermally melt-bonded.

By the above steps, the battery pack according to the embodiment of the invention is manufactured.

According to the embodiment of the invention, the following effects can be obtained.

The protecting circuit 32 is fitted into the first groove 22 of the lower molding body 21 and the protecting circuit substrate 31 is fitted into the second groove 23. The molten resin is filled onto the protecting circuit substrate 31 so as to fill the second groove 23 and hardened and the upper molding body 41 is formed, thereby obtaining the front cover 2. The auxiliary tabs 33a and 33b provided for the protecting circuit substrate 31 and the leads 5a and 5b are joined. After that, the front cover 2 is fitted into the opening of the front side of the battery device 4 covered with the external package 1. The molten resin is filled between the battery device 4 and the front cover 2 from the resin injection holes 25a and 25b and hardened. Since the lower molding body 21 exists between the molten resin and the protecting circuit 32, it is possible to prevent the heat of the molten resin from being directly propagated to electronic parts such as a protecting circuit and the like. Therefore, the front cover and the battery device 4 can be integrated without damaging the electronic parts such as a protecting circuit and the like.

Although the embodiment of the invention has specifically been described above, the invention is not limited to the foregoing embodiment but various modifications based on the technical idea of the invention are possible.

For example, the numerical values mentioned in the foregoing embodiment are merely shown as an example and other numerical values different from them can be also used as necessary.

Although the example in which the invention is applied to the non-aqueous electrolyte secondary battery of the winding type in that the electrolyte layer is provided between the positive electrode and the negative electrode and the positive and negative electrodes are wound has been described in the above embodiment, the invention can be also applied to a non-aqueous electrolyte secondary battery of a laminating type in which the positive electrode, the electrolyte layer, and the negative electrode are sequentially laminated.

Although the example in which the invention is applied to the battery having the gel electrolyte as an electrolyte has been described in the above embodiment, the invention can be also applied to a battery having a solid electrolyte containing electrolyte salt as an electrolyte. The invention can be also applied to a battery having an electrolyte solution such as a non-aqueous electrolyte solution or the like as an electrolyte.

Although the case where the step of forming the upper molding body 41 and the step of injecting the molten resin into the resin injection holes 25a and 25b are separately executed has been shown as an example in the above embodiment, those steps can be also executed in the same step. In such a case, such an advantage that the number of steps is reduced and manufacturing efficiency can be further improved can be obtained.

It should be understood by those skilled in the art that various modifications, combinations, sub-combinations and alterations may occur depending on design requirements and other factors insofar as they are within the scope of the appended claims or the equivalents thereof.

What is claimed is:

1. A battery pack having at least
a battery device enclosed in an external package and
a cover adapted to be fitted into an opening formed at one end of the battery device enclosed in said external package,
wherein said cover comprises:
a lower molding body;
a circuit substrate arranged on the side of said lower molding body opposite to the side of the battery device; and
an upper molding body provided on said circuit substrate,
said circuit substrate and a lead led out of said opening are joined, and
the battery device enclosed in said external package and said cover are adhered with a resin.

2. A pack according to claim 1, wherein said cover has two or more resin injection holes for filling said resin between the battery device enclosed in said external package and said cover from an outside.

3. A pack according to claim 2, wherein said resin injection hole has a groove in an injection port of said resin injection hole and said resin is filled up to said groove.

4. A manufacturing method of a battery pack, comprising the steps of:
arranging a circuit substrate to a lower molding body;
providing an upper molding body onto said circuit substrate;
joining an upper surface of the circuit substrate arranged on said lower molding body and a lead led out of an opening provided at one end of a battery device enclosed in an external package;
inserting said lower molding body into said opening so that the surface of the lower molding body where said circuit substrate is arranged faces an outside; and
injecting a resin between said lower molding body and said battery device and hardening it.

5. A method according to claim 4, wherein said resin is injected through two or more resin injection holes provided in a cover.

6. A method according to claim 5, wherein said resin is filled up to a groove formed in an injection port of said resin injection hole.

7. A manufacturing method of a battery pack, comprising the steps of:
arranging a circuit substrate to a lower molding body;
joining an upper surface of the circuit substrate arranged on said lower molding body and a lead led out of an opening provided at one end of a battery device enclosed in an external package;
inserting said lower molding body into said opening so that the surface of the lower molding body where said circuit substrate is arranged faces an outside; and
filling a resin onto said circuit substrate, forming an upper molding body, injecting the resin between said lower molding body and said battery device, and hardening it.

8. A method according to claim 7, wherein said resin is injected through two or more resin injection holes provided in a cover.

9. A method according to claim 8, wherein said resin is filled up to a groove formed in an injection port of said resin injection hole.
